(19) United States
(12) Patent Application Publication
(10) Pub. No.: US 2018/0201467 A1
(43) Pub. Date: Jul. 19, 2018

(54) SHEET POST-PROCESSING APPARATUS

(71) Applicants: KABUSHIKI KAISHA TOSHIBA, Tokyo (JP); TOSHIBA TEC KABUSHIKI KAISHA, Tokyo (JP)

(72) Inventors: Hiroyuki TAKI, Mishima Shizuoka (JP); Kimie KAMATA, Suntou Shizuoka (JP); Isao YAHATA, Izunokuni Shizuoka (JP)

(21) Appl. No.: 15/630,844

(22) Filed: Jun. 22, 2017

(30) Foreign Application Priority Data
Jan. 18, 2017 (JP) 2017-006857

(51) Int. Cl. B65H 45/30; B65H 45/18; B65H 37/04; B42C 9/00; B65H 37/02

(52) U.S. Cl. CPC B65H 45/30; B65H 45/18; B42C 1/125; B42C 9/0081; B65H 37/02; B65H 37/04

(57) ABSTRACT

A sheet post-processing apparatus includes a sheet folding unit and a binding processing unit. The sheet folding unit is located along a conveyance path of a sheet to be folded and performs folding processing on the sheet to form a folded body having a fold along a direction crossing a sheet conveyance direction. The binding processing unit is located downstream of the sheet folding unit in the sheet conveyance direction and performs binding processing on the folded body to bind a lateral side of the folded body.

### CROSS-REFERENCE TO RELATED APPLICATION

This application is based upon and claims the benefit of priority from Japanese Patent Application No. 2017-006857, filed Jan. 18, 2017, the entire contents of which are incorporated herein by reference.

### FIELD

Embodiments described herein relate generally to a sheet post-processing apparatus.

### BACKGROUND

A post-processing apparatus for performing post-processing on a sheet conveyed from an image processing apparatus (for example, an MFP) is known. Types of the post-processing apparatus include one provided with a processing unit for stapling and/or sorting a conveyed sheet and one provided with a sheet folding unit for bundling a plurality of sheets and folding the sheet bundle into two, i.e., performing the so-called saddle folding.

Meanwhile, since the post-processing apparatus includes various functional units, it is desirable to use these functional units to further create an added value and to improve the marketability of the post-processing apparatus.

### DESCRIPTION OF THE DRAWINGS

FIG. 1 is a front view illustrating a configuration of an image forming system according to an embodiment.

FIG. 2 is a block diagram illustrating the configuration of the image forming system according to the embodiment.

FIG. 3 is a perspective view illustrating a configuration of a sheet folding unit of a post-processing apparatus according to the embodiment.

FIG. 4 is a perspective view illustrating action of the sheet folding unit according to the embodiment.

FIG. 5 is a perspective view illustrating actions of the sheet folding unit and a binding processing unit according to the embodiment.

FIG. 6 is a perspective view of a folder formed by the post-processing apparatus according to the embodiment.

FIG. 7 is a perspective view of another example of the folder formed by the post-processing apparatus according to the embodiment.

FIG. 8 is a first front view illustrating layout of a folding roller and an ejection roller according to the embodiment.

FIG. 9 is a second front view illustrating layout of the folding roller and the ejection roller according to the embodiment.

FIG. 10 is a perspective view illustrating a modification of the embodiment and corresponding to FIG. 5.

FIG. 11 is a perspective view illustrating another modification of the embodiment and corresponding to FIG. 3.

FIG. 12 is a perspective view illustrating another modification of the embodiment and corresponding to FIG. 6.

### DETAILED DESCRIPTION

Embodiments provide a post-processing apparatus which performs post-processing on a sheet.

In general, according to one embodiment, a sheet post-processing apparatus includes a sheet folding unit and a binding processing unit. The sheet folding unit is located along a conveyance path of a sheet to be folded, and performs folding processing on the sheet to form a folded body having a fold along a direction crossing a sheet conveyance direction. A binding processing unit is located downstream of the sheet folding unit in the sheet conveyance direction and performs binding processing on the folded body to bind a lateral side of the folded body.

A post-processing apparatus according to an embodiment will be described hereinafter with reference to the drawings. In the following illustration of the drawings, same or similar constituent elements are denoted by the same reference symbols. In addition, configurations of those constituent elements are often not repeatedly described.

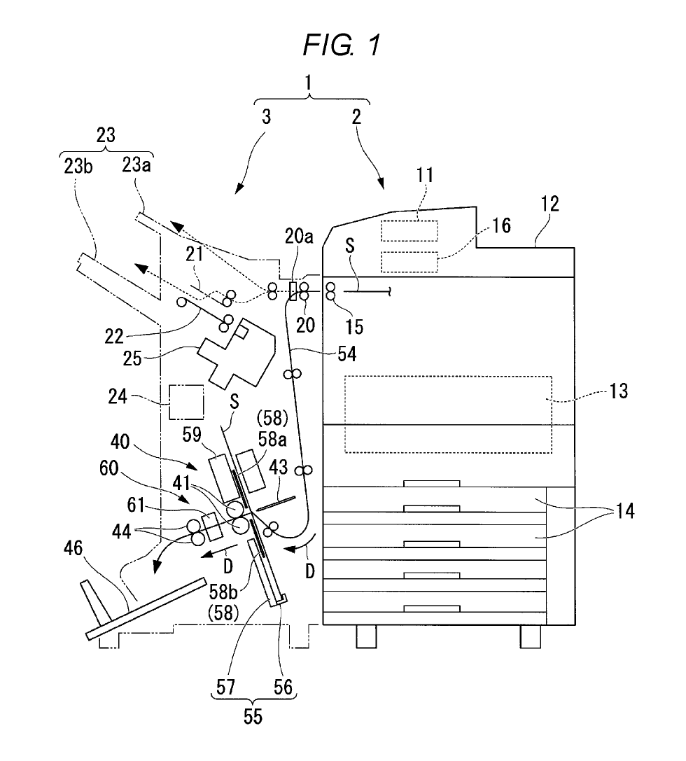

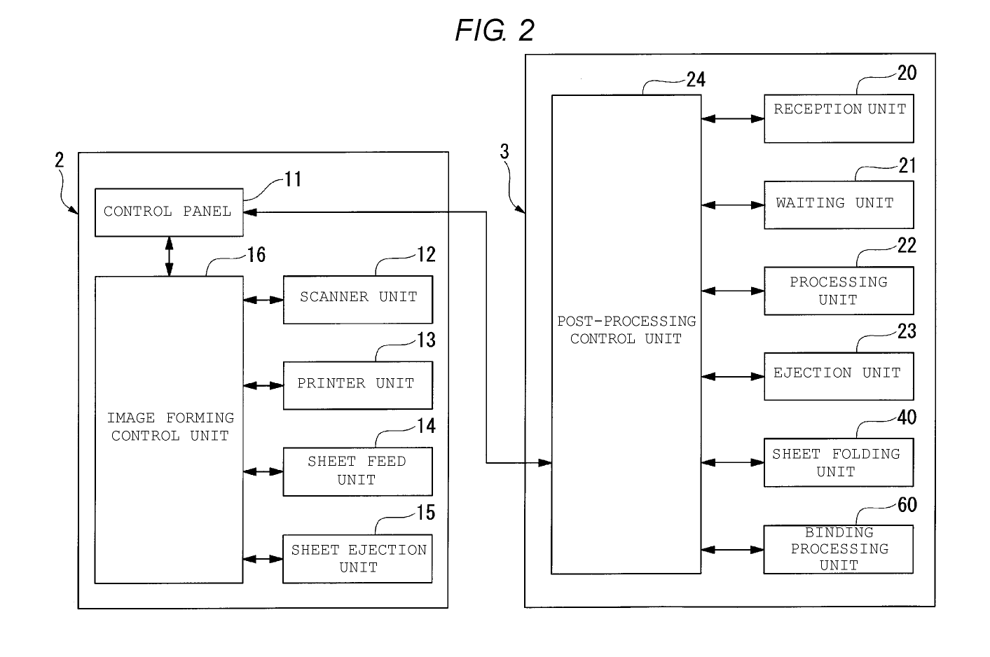

FIGS. 1 and 2 illustrate an exemplary overall configuration of an image forming system 1. The image forming system 1 includes an image forming apparatus 2 and a post-processing apparatus 3. The image forming apparatus 2 forms an image on a sheet-like recording medium (hereinafter, referred to as “sheet S”) such as a paper sheet. Examples of the image forming apparatus 2 include an MFP (Multi-Function Peripherals) which is a multifunction machine, a printer, and a copier. The post-processing apparatus 3 performs post-processing on the sheet S conveyed from the image forming apparatus 2. Types of the sheet S include not only the paper sheet but also a plastic sheet such as an OHP (Overhead projector) sheet. The post-processing apparatus 3 can form a so-called clear file or folder by performing the post-processing on the plastic sheet. The sheet S which is fed is not limited to the sheet S fed from the image forming apparatus 2 to the post-processing apparatus 3, but the sheet S can be manually fed to the post-processing apparatus 3.

The image forming apparatus 2 includes a control panel 11, a scanner unit 12, a printer unit 13, a sheet feed unit 14, a sheet ejection unit 15, and an image forming control unit 16.

The control panel 11 includes various keys, a touch panel, and the like to receive a user's operation inputs. For example, the control panel 11 receives an input related to a type of the post-processing to be performed on the sheet S. The image processing apparatus 2 sends information about the type of the post-processing selected on the control panel 11 to the post-processing apparatus 3.

The scanner unit 12 includes a reader unit that reads image information on an object to be copied. The scanner unit 12 sends the read image information to the printer unit 13.

The printer unit 13 forms an output image (hereinafter, referred to as “toner image”) with a developer such as a toner on the basis of the image information sent from the scanner unit 12 or an external device. The printer unit 13 transfers the toner image onto a front surface of the sheet S. The printer unit 13 applies a heat and a pressure to the toner image transferred onto the sheet S to fix the toner image onto the sheet S.

The sheet feed unit 14 feeds sheets S to the printer unit 13 one by one in accordance with timing at which the printer unit 13 forms the toner image.

The sheet ejection unit 15 ejects each sheet S conveyed from the printer unit 13 to the post-processing apparatus 3.

The image forming control unit 16 controls an overall operation performed by the image forming apparatus 2. That is, the image forming control unit 16 controls the control panel 11, the scanner unit 12, the printer unit 13, the sheet feed unit 14, and the sheet ejection unit 15. The image forming control unit 16 is configured with a control circuit that includes a CPU (Central Processing Unit), a ROM (Read Only Memory), and a RAM (Random Access Memory).

The post-processing apparatus 3 will next be described.

The post-processing apparatus 3 is disposed, for example, to be adjacent to the image forming apparatus 2. The sheet S is conveyed from the image forming apparatus 2 to the post-processing apparatus 3. The post-processing apparatus 3 performs the post-processing, which is designated through the control panel 11, on the conveyed sheet S. For example, the post-processing apparatus 3 performs stapling processing and sorting processing. For example, the post-processing apparatus 3 performs sheet folding processing to fold the sheet S into two and to eject the folded sheet S.

The post-processing apparatus 3 includes a reception unit 20, a waiting unit 21, a processing unit 22, an ejection unit 23, and a post-processing control unit 24.

The reception unit 20 is disposed to be continuous with a downstream side, in a conveying direction, of the sheet ejection unit 15 and receives the conveyed sheet S. A manual feed tray (not shown) is connected to the sheet ejection unit 15.

The waiting unit 21 temporarily holds (or buffers) the sheet S conveyed from the image forming apparatus 2. The waiting unit 21 is provided above the processing unit 22. The waiting unit 21 drops the held sheet S toward the processing unit 22 when the processing unit 22 becomes empty.

The processing unit 22 performs the post-processing on the conveyed sheet S. For example, the processing unit 22 performs the sorting processing to collate and align a plurality of sheets S. For example, the processing unit 22 performs sheet binding processing on a sheet bundle in which the plurality of sheets S are collated with staples or an adhesive tape. Reference symbol 25 in FIG. 1 denotes a sheet binder which performs the binding processing on the sheet bundle placed in the processing unit 22 with the staples or the like. The processing unit 22 ejects the post-processed sheet S to the ejection unit 23.

The ejection unit 23 includes a fixed tray 23a and a movable tray 23b. The fixed tray 23a is provided in an upper portion of the post-processing apparatus 3. The movable tray 23b is movably provided in a lateral portion of the post-processing apparatus 3. The sheet S is ejected to the fixed tray 23a or the movable tray 23b from the processing unit 22.

The post-processing control unit 24 controls an overall operation performed by the post-processing apparatus 3. That is, the post-processing control unit 24 controls operations performed by the reception unit 20, the waiting unit 21, the processing unit 22, and the ejection unit 23, as well as operations performed by a sheet folding unit 40 and a binding processing unit 60 to be described later. In one embodiment, the post-processing control unit 24 includes a control circuit that includes a CPU, a ROM, and a RAM, similarly to the image forming control unit 16.

The sheet folding unit 40 and the binding processing unit 60 of the post-processing apparatus 3 will next be described.

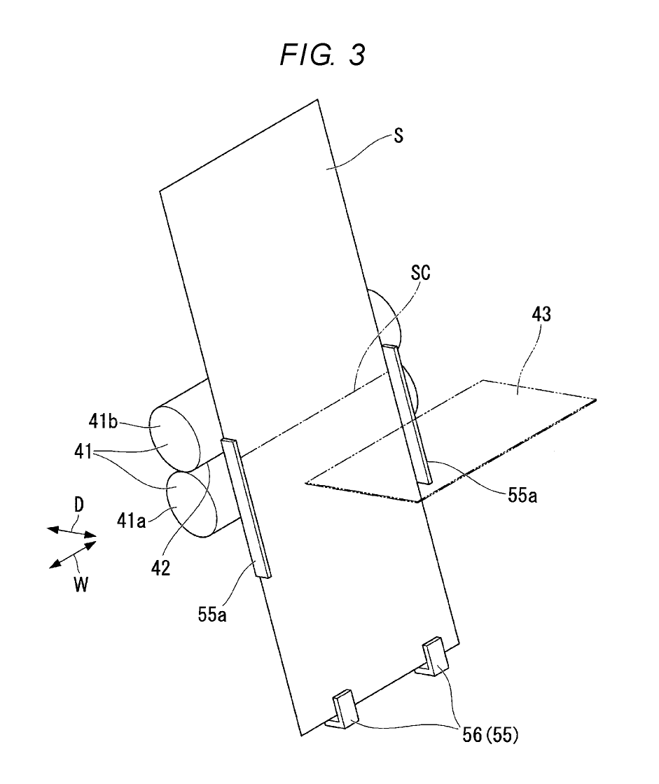

As shown in FIGS. 1, 3, and 4, the post-processing apparatus 3 includes the sheet folding unit 40 which folds a single sheet S or a plurality of sheets S into two (i.e., which performs saddle folding thereon), and the binding processing unit 60 which binds lateral sides H2 of the folded sheet or sheets S (hereinafter, often referred to as “folded body S2”).

The post-processing apparatus 3 conveys the sheet S along a route which is along a surface of a sheet of FIG. 1. Front and rear surfaces of the sheet S are disposed in parallel to a direction orthogonal to the sheet of FIG. 1. Hereinafter, a direction along the route of conveying the sheet S in the sheet folding unit 40 will be referred to as “sheet conveying direction D” (or simply “conveying direction D”) and the direction orthogonal to the sheet of FIG. 1 will be referred to as “sheet width direction W”. Each of the sheet S and the folded body S2 is of a rectangular shape having two sides along the sheet conveying direction D and two sides along the sheet width direction W. The downstream side, in the conveying direction D, of the folded body S2 is defined as a folded side H1 and the sides of the folded body S2 extending from an end of the folded side H1 in the sheet width direction W are defined as the lateral sides H2.

The sheet S is conveyed to the sheet folding unit 40 from the image forming apparatus 2 via a sheet path 54. The sheet S conveyed to the sheet folding unit 40 is received by a stacker 55.

For example, the stacker 55 receives the conveyed sheet S in a standing profile. The stacker 55 tilts the sheet S so that an upper side of the received sheet S is located downstream in the conveying direction D (on a side closer to a folding roller 41).

In order to fold the plurality of sheets S into two, the plurality of sheets S are sequentially stacked and received by the stacker 55 and formed into a bundle.

Each of the sheets S (or simply “sheet bundle”) received by the stacker 55 is supported by a guide member 58. At this time, a central portion SC of the sheet S faces a nip part 42 of the folding roller 41 in a thickness direction of the sheet S supported on the guide member 58. A folding blade 43 is disposed in a region facing the nip part 42 across the sheet S in the thickness direction of the sheet S.

The folding blade 43 pushes the central portion SC of the sheet S toward the nip part 42 of the folding roller 41 and pushes the central portion SC of the sheet S into the nip part 42. The folding roller 41 rotates while nipping the central portion SC of the sheet and folds the sheet S into two. The folded sheet S (folded body S2) is conveyed by an ejection roller 44 located downstream, in the conveying direction D, of the nip part 42 and ejected to an ejection tray 46. The folding roller 41 and the ejection roller 44 are driven to rotate by a driving motor (not shown) either independently or synchronously.

As shown in FIG. 1, a gate 20a is provided in the reception unit 20 of the post-processing apparatus 3 to switch over a conveying destination of the sheet S conveyed from the image processing apparatus 2 between the processing unit 22 and the sheet folding unit 40. The gate 20a guides the sheet S conveyed from the image processing apparatus 2 toward the processing unit 22 when the sheet folding processing is not performed on the sheet S and guides the sheet S toward the sheet folding unit 40 when the sheet folding processing is performed on the sheet S.

The sheet folding unit 40 includes the folding roller 41 and the folding blade 43.

The folding roller 41 is configured with a pair of rollers forming the nip part 42. One of the pair of rollers of the folding roller 41 is a drive roller 41a and the other roller is a driven roller 41b. The drive roller 41a is driven to rotate at a fixed position without moving. The drive roller 41a is driven by a drive source (for example, a DC motor) which is not shown. The driven roller 41b is separable from the drive roller 41a and biased toward the drive roller 41a by a biasing mechanism (e.g., a spring, which is not shown). The central portion SC of the sheet S is pushed into the nip part 42 of the folding roller 41 by the folding blade 43. The folding roller 41 folds the sheet S inserted into the nip part 42 into two and conveys the folded sheet S downstream in the conveying direction D.

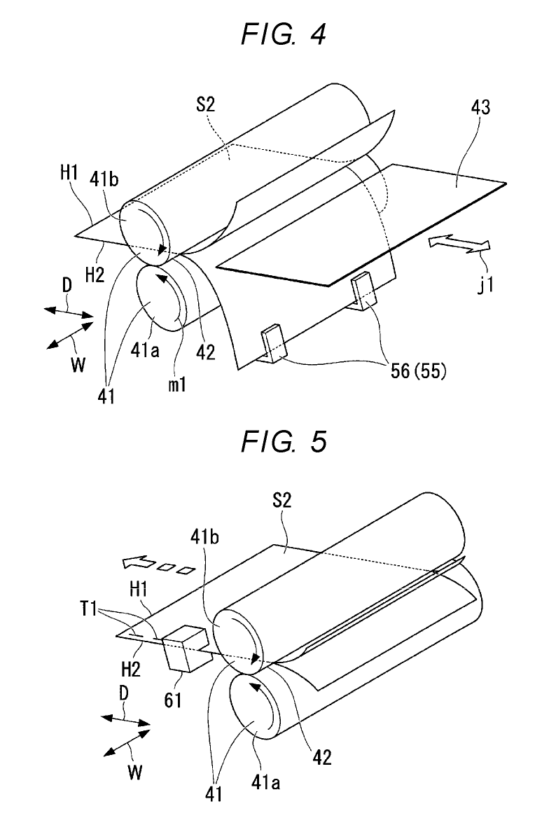

For example, a DC motor is used as the drive source of the drive roller 41a. The drive source transmits a driving force to the drive roller 41a. For example, when the drive source drives the drive roller 41a, the drive roller 41a rotates in a direction of an arrow ml shown in FIG. 4. The driven roller 41b rotates to follow up rotation of the drive roller 41a. For example, the drive source of the drive roller 41a also transmits a driving force to the folding blade 43. For example, the folding blade 43 reciprocates in a direction of an arrow j1 shown in FIG. 4 by using a slider crank mechanism. When the drive source of the drive roller 41a drives the driver roller 41a and the folding blade 43, the drive roller 41a rotates in the direction of the arrow ml and the folding blade 43 reciprocates in the direction of the arrow j1. When the folding blade 43 moves forward, then the central portion SC of the sheet S is pushed into the nip part 42 and the folded side H1 is formed on the sheet S. After the folded side H1 is formed on the sheet S, the folding blade 43 moves backward and exits the nip part 42. Sharing the drive source between the folding blade 43 and the drive roller 41a can simplify a configuration of the sheet folding unit 40, compared with a case of providing separate drive sources.

The folding blade 43 is a plate member having a thickness in a direction in which the pair of rollers of the folding roller 41 face each other. The folding blade 43 can reciprocate so that a front-end edge thereof is inserted into or released from the nip part 42. The folding blade 43 enters the nip part 42 while pushing the central portion SC of the sheet S into the nip part 42. The folding blade 43 retracts from the nip part 42 while leaving the central portion SC of the sheet S in the nip part 42.

As shown in FIG. 1, the guide member 58 is disposed between the folding roller 41 and the sheet S in the sheet conveying direction D. The guide member 58 is a plate member orthogonal to a movement direction of the folding blade 43 and parallel to a rotational axis of the folding roller 41. The guide member 58 guides the sheet S conveyed from the sheet path 54 for mounting in the stacker 55. The guide member 58 is divided into a first guide member 58a and a second guide member 58b with a clearance given therebetween such that the folding blade 43 can move forward and backward. The folding blade 43 which moves forward can push the central portion SC of the sheet S into the nip part 43 through the clearance between the first guide member 58a and the second guide member 58b and then move backward.

The stacker 55 includes support claws 56 supporting a lower end of the sheet S and a moving apparatus 57 moving the support claws 56 vertically. A first staple unit 59 is disposed above the stacker 55. The first staple unit 59 performs the stapling processing on the central portion SC of the sheet S in advance in accordance with the type of the post-processing. The sheet S set in the stacker 55 can be moved vertically according to movement of the support claws 56. For example, the support claws 56 also rise in response to a displacement of the lower end of the sheet S when the folding blade 43 pushes the sheet S into the nip part 42. The sheet S mounted in the stacker 55 is aligned by causing the support claws 56 to support the lower end of the sheet S. A pair of alignment members 55a are disposed on both sides of the stacker 55 in the sheet width direction W, respectively to position the sheet S in the sheet width direction W.

The ejection roller 44 is disposed in a region apart from the folding roller 41 downstream in the conveying direction D to eject the folded body S2 downstream in the conveying direction D.

The ejection roller 44 is configured from a pair of rollers forming a nip part 45. One of the pair of rollers of the ejection roller 44 is a drive roller and the other roller is a driven roller. The drive roller is driven to rotate at a fixed position without moving. The driven roller is separable from the drive roller and biased toward the drive roller by a biasing mechanism (e.g., a spring, not shown). The folded body S2 (or a folder F1 to be described later) conveyed by the folding roller 41 is nipped into the nip part 45 of the ejection roller 44. The ejection roller 44 delivers the folded body S2 or (or the folder F1) inserted into the nip part 45 downstream in the conveying direction D. The nip part 45 of the ejection roller 44 faces the nip part 42 of the folding roller 41 in the sheet conveying direction D.

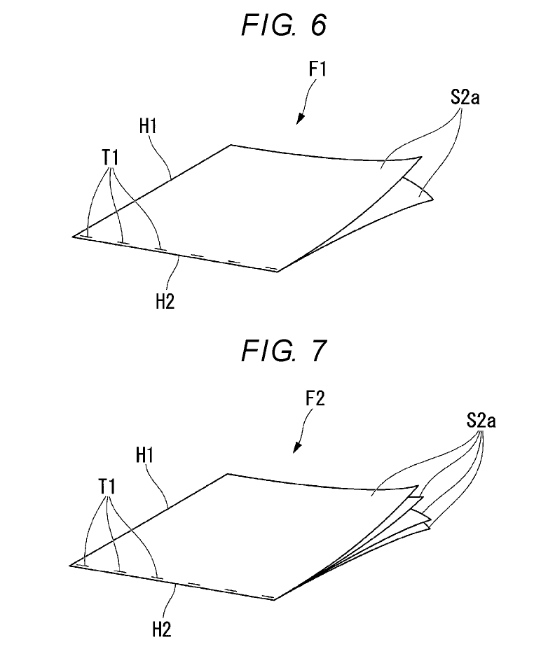

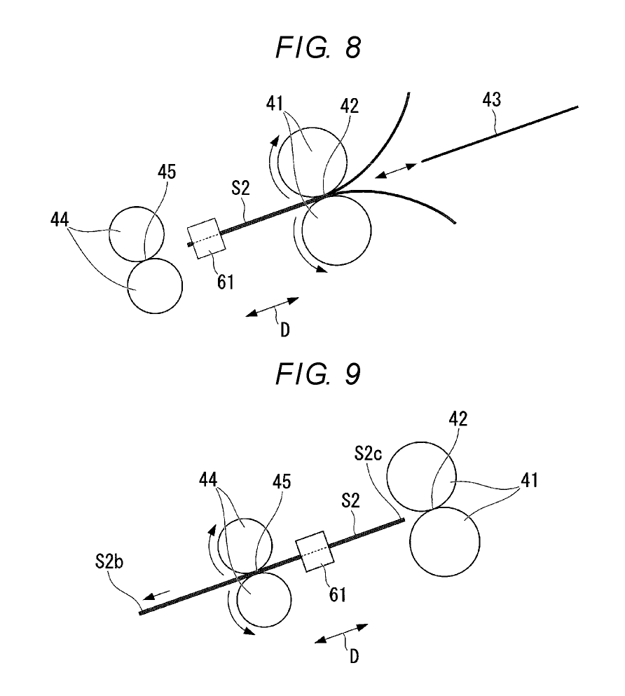

As shown in FIGS. 1, 5, 8, and 9, the binding processing unit 60 is disposed between the folding roller 41 and the ejection roller 44. The binding processing unit 60 includes, for example, a second staple unit 61. The second staple unit 61 performs processing on the folded body S2 passing through the folding roller 41 to bind the lateral sides H2. The folded body S2 is conveyed in such a manner that the folded side H1 along the sheet width direction W is faced downstream in the conveying direction D. The second staple unit 61 binds the lateral sides H2 of the folded body S2 on one side in the sheet width direction W. As a result, at least a pair of sheet parts S2a demarcated by a bend line of the folded side H1 of the folded body S2 are bound together at the folded side H1 and the lateral sides H2 extending from one end of the folded side H1 upstream in the conveying direction D. That is, the sheet folding unit 40 and the binding processing unit 60 cooperate with each other to form the folder F1 by binding a plurality of sheet parts S2a of the folded body S2 into an L-shape in a plan view (see FIG. 6).

As shown in FIG. 9, while the folded body S2 is being conveyed to the folding roller 41, an end portion S2b, which is downstream in the conveying direction D, of the folded body S2 reaches the nip part 45 of the ejection roller 44. After separating from the folding roller 41, the folded body S2 is conveyed by the ejection roller 44. Owing to this, the binding processing unit 60 can perform the binding processing on the lateral sides H2 up to an end portion S2c, which is upstream end in the deliver direction D, of the folded body S2.

The binding processing unit 60 binds the lateral sides H2 by the second staple unit 61. For example, the second staple unit 61 staples the lateral sides H2 at a fixed position without moving. The folding roller 41 and the ejection roller 44 are driven intermittently to convey the folded body S2. The second staple unit 61 binds the lateral sides H2 whenever the folded body S2 is temporarily stopped. The second staple unit 61 forms a plurality of bound parts T1 in the lateral sides H2 of the folded body S2 to be spaced apart from one another. The second staple unit 61 may perform stapling while moving in the sheet conveying direction D shown in FIG. 9.

As described so far, the post-processing apparatus 3 according to the present embodiment performs the post-processing on the sheet S conveyed from the image processing apparatus 2, and includes the sheet folding unit 40 performing the folding processing on the sheet S conveyed from the image processing apparatus 2 to form the folded body S2 having the folded side H1 crossing the sheet conveying direction D; and the binding processing unit 60 performing the binding processing on the folded body S2 conveyed from the sheet folding unit 40 to bind the lateral sides H2 extending from the end of the folded side H1 of the folded body S2 in the direction crossing the folded side H1.

With this configuration, the plurality of sheet parts S2a forming the folded body S2 can be bound together into the L-shape in a plan view by the folded side H1 and the lateral sides H2 having been subjected to the binding processing. Owing to this, it is possible to easily form the folder F1 having a pocket into which a document and the like are inserted and to improve merchantability of the post-processing apparatus 3.

FIG. 7 illustrates a folder F2 formed through multiple folding processing for stacking and folding a plurality of sheets S. In the multiple folding processing, the plurality of sheets (or sheet bundle) received by the stacker 55 are simultaneously folded into two by one reciprocating motion of the folding blade 43. Furthermore, the second staple unit 61 performs the binding processing on the folded body S2 configured from the plurality of sheets S. A command to stack the plurality of sheets S to perform the folding processing and the binding processing can be input through the control panel 11. The post-processing control unit 24 feeds the plurality of sheets S to the stacker 55 of the sheet folding unit 40 into a stacked state on the basis of the command input to the control panel 11. The post-processing control unit 24 performs the folding processing simultaneously on the plurality of sheets S stacked in the stacker 55. The post-processing control unit 24 feeds the folded body S2 configured by stacking and folding the plurality of sheets S to the binding processing unit 60 to perform the binding processing for binding the lateral sides H2 of the folded body S2.

In this way, by binding the folded body S2 configured by stacking and folding the plurality of sheets S into the L-shape in a plan view, it is possible to form the folder F2 having a plurality of pockets. It is also possible to combine sheets S formed from different materials. For example, it is possible to form a front cover and intermediate pages of the folder F2 from different materials. It is, therefore, possible to further improve the merchantability of the post-processing apparatus 3.

In the post-processing apparatus 3 according to the present embodiment, the sheet folding unit 40 includes the folding roller 41 forming the nip part 42 for folding the sheet S, the ejection roller 44 delivering the folded body S2 downstream in the conveying direction D is disposed in a region apart from the folding roller 41 downstream in the conveying direction D, and the binding processing unit 60 is disposed between the folding roller 41 and the ejection roller 44.

It is thereby possible to deliver the folded body S2 folded by the folding roller 41 downstream in the conveying direction D while the binding processing unit 60 performs the binding processing on the lateral sides H2 of the folded body S2. Moreover, the folded body S2 reaches the ejection roller 44 while being conveyed to the folding roller 41, so that the ejection roller 44 can subsequently deliver the folded body S2 and the lateral sides H2 of the folded body S2 can be easily bounded up to the end portion S2c, which is upstream in the conveying direction D, of the folded body S2.

In the post-processing apparatus 3 according to the present embodiment, the binding processing unit 60 intermittently forms the bound parts T1 in the lateral sides H2 of the folded body S2.

It is thereby possible to provide a configuration appropriate for the binding processing using the staples, the tape or the like. Furthermore, adjusting pitches of the plurality of bound parts T1 makes it possible to shorten binding time and to suppress consumption of materials and energy, compared with a configuration in which the lateral sides H2 are continuously bound without intervals.

In the embodiment described above, the binding processing unit 60 performs the binding using the staples; however, the binding processing unit 60 is not limited to this configuration. For example, the binding processing unit 60 may include a so-called stapleless binding unit which binds the sheets S by tucking in a cut-and-raised piece or by press-fitting the sheets S. Alternatively, the binding processing unit 60 may include a sheet binder binding the sheets S in various manners such as a tape binding unit using a binding tape.

Moreover, the object to be processed is not limited to the paper sheet but a resin sheet may be used as the object to be processed. In this case, the binding processing unit 60 may be configured to bind the resin sheets by thermal deposition.

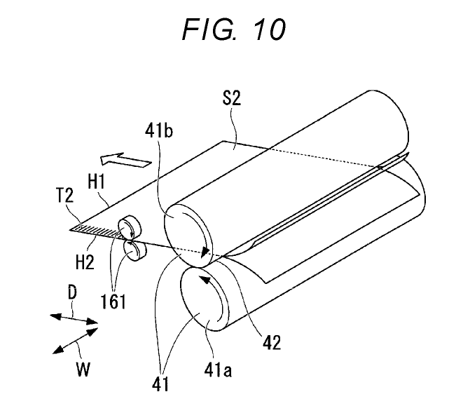

FIG. 10 illustrates a configuration in which the binding processing unit 60 includes thermal deposition rollers 161 and the thermal deposition rollers continuously form bound parts T2 in the lateral side H2 of the folded body S2 configured from the resin sheet. The thermal deposition rollers 161 can be replaced by, for example, pressure rollers. In this case, not only the resin sheet but also the paper sheet can be used as the object to be processed.

It is possible to provide the configuration suited for the binding processing using the pressure rollers, the thermal deposition rollers or the like when the bound parts T2 are formed continuously. Furthermore, it is possible to form the convenient folder F1 or F2 without an opening in the lateral sides H2 after the binding processing.

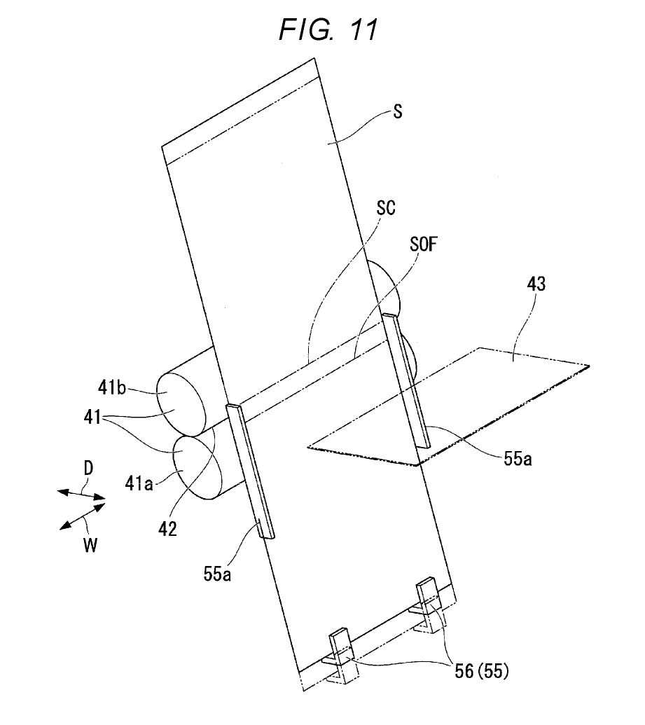

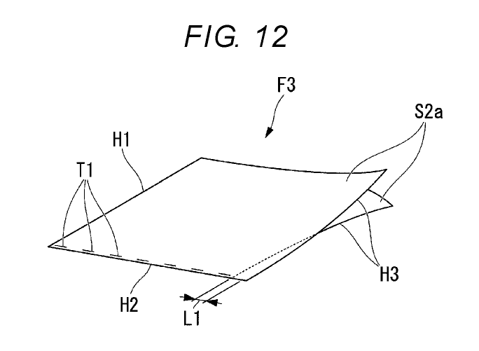

FIGS. 11 and 12 illustrate an example of folding the sheet S into two at an offset position SOF shifted downward from the central portion SC of the sheet SC. In this example, the support claws 56 of the stacker 55 are moved upward, compared with a case of folding the sheet S into two in the central portion SC of the sheet S. With this configuration, the offset position SOF shifted downward from the central portion SC of the sheet S faces the nip part 42 of the folding roller 41 in the thickness direction of the sheet S. In this state, the folding blade 43 moves forward and backward as the folding roller 41 is driven, and the sheet S is folded into two at the offset portion SOF to form the folded body S2.

In the folded body S2 in this example, upper and lower sheet ends H3 upstream in the conveying direction D are shifted from each other by L1 (see FIG. 12). By performing the binding processing on the lateral sides H2 of this folded body S2, a folder F3 is formed such that the sheet ends H3 opposite to the folded side H1 are shifted from each other. While FIG. 12 illustrates the folder F3 formed from a single sheet S, the folder F3 may be formed by stacking a plurality of sheets S (see FIG. 7). While FIG. 12 illustrates the folder F3 having the bound parts T1 formed intermittently in the lateral sides H2 of the folded body S2, the folder F3 may be formed such that the bound parts T2 are formed continuously in the lateral sides H2. (see FIG. 10)

A command to set a position of the folded side H1 to the offset position SOF can be input through the control panel 11. The post-processing control unit 24 moves the support claws 56 of the stacker 55 on the basis of the command input to the control panel 11. If the control panel 11 receives the command input, the post-processing control unit 24 shifts the sheet S by moving the support claws 56 in a direction parallel to the surface of the guide member 58 such that the position of a portion, on which a bent line will be formed, of the sheet S is shifted to the offset position SOF from the center of the sheet S, and then pushes the sheet S into the nip part 42 by the folding blade 43 to fold the sheet S.

The post-processing control unit 24 feeds the folded body S2 having the sheet ends H3 opposite to the folded side H1 and shifted from each other to the binding processing unit 60, and the binding processing unit 60 performs the binding processing for binding the lateral sides H2 of the folded body S2.

While the configuration of the post-processing apparatus 3 according to one embodiment has been described so far, the configuration is not limited to those in the examples. For example, the post-processing apparatus 3 may be included in the image forming apparatus 2 having an inner finisher provided in a housing thereof. For example, when the post-processing apparatus 3 is independent of the image forming apparatus 2, the post-processing apparatus 3 may include an operation receiving unit similar to the control panel 11.

According to at least one embodiment described so far, by comprising the sheet folding unit 40 and the binding processing unit 60, it is possible to improve the merchantability of the post-processing apparatus 3.

That is, by performing the post-processing on the plastic sheet, it is possible to form the so-called clear file (or folder).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sheet post-processing apparatus comprising:
a sheet folding unit located along a conveyance path of a sheet to be folded, the sheet folding unit performing folding processing on the sheet to form a folded body having a fold along a direction crossing a sheet conveyance direction; and
a binding processing unit located downstream of the sheet folding unit in the sheet conveyance direction, the binding processing unit performing binding processing on the folded body to bind a lateral side of the folded body.

2. The sheet post-processing apparatus according to claim 1, wherein the lateral side of the folded body includes lateral sides of folded portions of the sheet and extends from one end of the fold in a direction opposite the sheet conveyance direction.

3. The sheet post-processing apparatus according to claim 1, further comprising:
a control unit configured to control the sheet folding unit and the binding processing unit responsive to an input of a command to perform the folding processing on a plurality of sheets and the binding processing on the folded body of the plurality of sheets, wherein
upon receipt of the command, the control unit controls the sheet folding unit to perform the folding processing simultaneously on the plurality of sheets, and the binding processing unit to perform the binding processing on the folded body of the plurality of sheets.

4. The sheet post-processing apparatus according to claim 1, wherein the sheet folding unit includes a pair of rollers forming a nip, and a folding blade that is moved to push a center portion of the sheet into the nip.

5. The sheet post-processing apparatus according to claim 4, wherein the pair of rollers includes:
a first roller that is driven to convey the folded body in the sheet conveyance direction, and
a second roller that is driven by the first roller and forms the nip with the first roller.

6. The sheet post-processing apparatus according to claim 1, wherein
the binding processing unit is configured to form a bind along the lateral side of the folded body that is intermittent.

7. The sheet post-processing apparatus according to claim 1, wherein
the binding processing unit configured to form a bind along the lateral side of the folded body that is continuous.

8. The sheet post-processing apparatus according to claim 1, comprising:
a control unit configured to control the sheet folding unit and the binding processing unit responsive to an input of a command to set a position of the fold that is offset from a center of the sheet, wherein
upon receipt of the command, the control unit controls the sheet folding unit to perform the folding processing on the sheet such that the fold is located offset from the center of the sheet, and the binding processing unit to perform the binding processing on the folded body.

9. An image forming system comprising:
an image forming apparatus configured to form an image on one or more sheets; and
a post-processing apparatus configured to perform post-processing on the one or more sheets, wherein the post-processing apparatus includes a sheet folding unit located along a conveyance path of the one or more sheets, and a binding processing unit located downstream of the sheet folding unit in a sheet conveyance direction, wherein
the sheet folding unit performs folding processing on the one or more sheets to forma folded body having a fold along a direction crossing the sheet conveyance direction, and
the binding processing unit performs binding processing on the folded body to bind a lateral side of the folded body.

10. The image forming system according to claim 9, wherein the lateral side of the folded body includes lateral sides of folded portions of the one or more sheets and extends from one end of the fold in a direction opposite the sheet conveyance direction.

11. The image forming system according to claim 9, further comprising:
an input unit capable of receiving an input of a command to perform the folding processing on a plurality of sheets and the binding processing on the folded body of the plurality of sheets, wherein
upon receipt of the command, a control unit of the post-processing apparatus controls the sheet folding unit to perform the folding processing simultaneously on the plurality of sheets, and the binding processing unit to perform the binding processing on the folded body of the plurality of sheets.

12. The image forming system according to claim 9, wherein the sheet folding unit includes a pair of rollers forming a nip, and a folding blade that is moved to push a center portion of the sheet into the nip.

13. The image forming system according to claim 12, wherein the pair of rollers includes:
a first roller that is driven to convey the folded body in the sheet conveyance direction, and
a second roller that is driven by the first roller and forms the nip with the first roller.

14. The image forming system according to claim 9, wherein
the binding processing unit is configured to form a bind along the lateral side of the folded body that is intermittent.

15. The image forming system according to claim 9, wherein
the binding processing unit configured to form a bind along the lateral side of the folded body that is continuous.

16. The image forming system according to claim 9, further comprising:
an input unit capable of receiving an input of a command to set a position of the fold that is offset from a center of the sheet, wherein
upon receipt of the command, a control unit of the post-processing apparatus controls the sheet folding unit to perform the folding processing on the sheet such that the fold is located offset from the center of the sheet, and the binding processing unit to perform the binding processing on the folded body.

17. A sheet post-processing method comprising:
performing folding processing on a sheet conveyed along a sheet conveyance direction to form a folded body having a fold along a direction crossing the sheet conveyance direction; and
performing binding processing on the folded body to bind a lateral side of the folded body.

18. The sheet post-processing method according to claim 17, wherein the lateral side of the folded body includes lateral sides of folded portions of the sheet and extends from one end of the fold in a direction opposite the sheet conveyance direction.

19. The sheet post-processing method according to claim 17, wherein
the binding processing is performed to form a bind along the lateral side of the folded body that is either intermittent or continuous.

20. The sheet post-processing method according to claim 17, wherein the fold is offset from a center of the sheet.
